(19) United States
(12) Patent Application Publication
(10) Pub. No.: US 2026/0067693 A1
(43) Pub. Date: Mar. 5, 2026

(54) REGISTERING SMART CONTRACT ON A BLOCKCHAIN NETWORK

(71) Applicant: Telefonaktiebolaget LM Ericsson (publ), Stockholm (SE)

(72) Inventors: Amedeo IMBIMBO, Caivano (NA) (IT); Crescenzo MALVONE, Torre del Greco, Napoli (IT); Francesco MARINIELLO, Castel San Giorgio, Salerno (IT); Massimo IOVENE, Naples (IT)

(21) Appl. No.: 19/108,280

(22) PCT Filed: Sep. 14, 2022
(86) PCT No.: PCT/SE2022/050810

§ 371 Date: Mar. 3, 2025

(51) Int. Cl. H04W 12/08; G06F 9/54; H04W 4/021

(52) U.S. Cl. CPC H04W 12/08; G06F 9/542; H04W 4/021

(57) ABSTRACT

A method performed by an application function, AF, device. The method includes sending a first message registering a smart contract on a blockchain network, for accessing a service provided by at least one network exposure function, NEF, device. The method includes sending a second message subscribing to notification of an event provided by the at least one NEF device. The method includes receiving at least one first response message notifying about the event, wherein receiving the first response message triggers an execution of the smart contract on the blockchain network.

### TECHNICAL FIELD

Embodiments herein relate to an application function (AF) device, a network exposure function (NEF) device, their corresponding methods, a method performed by a blockchain network, and their corresponding computer programs and computer program products.

### BACKGROUND

The Fifth Generation (5G) network architecture includes the possibility for an external AF to access services exposed by a telecom operator's or a Mobile Network Operator's (MNO) 5G network via exposure functions. 3GPP TS 23.501 V17.5.0 (2022-06-15) provides a system architecture for the 5G System.

With the current standardized architecture, a given external AF is required to interface each specific MNO's NEF in order to access the required service. There is an increasing number of virtual MNOs in the network scenarios envisioned with the 5G paradigm requiring multiple such interfaces.

There are applications that require access to more than one service of the MNOs. In this service exposure context, the different entities playing a role on a 5G platform like the MNOs, Over-The-Top (OTT) operators, tenants etc., need trustable, integrated, and correlated data.

Further, there is a need to assure that the data (such as events, information elements, etc.) is complete and not corrupted along the whole chain of data transmission from a Radio Access Network (RAN) to a Core Network (CN) to an Operation Support System (OSS) and the Business Support System (BSS), till the time it is consumed for business purposes by business services. Since the 5G Platform may serve different multiple MNOs, data integrity consumed by the different business services becomes even more important.

Collecting information by and/or for the services requires access to different data sources in system domains by following different methodologies, going through possibly different authorization paths and retrieving most likely non-homogenous data. Building up such data baseline and being able to have traceable transaction information from the request to the actual information delivery is currently unspecified, unregulated and possibly error prone.

Further problems relate to the trust and traceability of the operations and/or of the data produced by such operations. There is further a need to analyse the spread of data in different MNOs' networks.

### SUMMARY

An object of the invention is to improve access to services exposed by one or more network functions.

According to a first aspect, there is provided a method performed by an application function, AF, device. The method comprises sending a first message registering a smart contract on a blockchain network, for accessing a service provided by at least one network exposure function, NEF, device. The method comprises sending a second message subscribing to notification of an event provided by the at least one NEF device. The method comprises receiving at least one first response message notifying about the event, wherein receiving the first response message triggers an execution of the smart contract on the blockchain network. In an embodiment according to the first aspect, the method further comprises sending a request for authorizing the AF device to access the service, and receiving an authorization response, wherein the authorization response includes one of: an indication that the AF device is authorized or an indication that the AF device is not authorized.

In an embodiment according to the first aspect, the AF device is authorized according to a Role-based Authorization Control authorization procedure or a Task-based Authorization Control authorization procedure.

In an embodiment according to the first aspect, the event is a Fifth Generation, 5G, monitoring event or a Sixth Generation, 6G, monitoring event.

In an embodiment according to the first aspect, the 5G monitoring event is at least one of the following events:
User Equipment, UE, reachability;
Location Reporting;
Change of Subscription Permanent Identifier-Permanent Equipment Identifier, SUPI-PEI, association;
Roaming Status;
Number of UEs present in a geographic area; and
UE reachability for Short Message Service, SMS, delivery.

In an embodiment according to the first aspect, when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PULL.

In an embodiment according to the first aspect, wherein when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PUSH.

In an embodiment according to the first aspect, when the monitoring event is Number of UEs present in a geographic area, the smart contract comprises at least one of the following data:
a Service Capability Server/Application Server, SCS/AS, Identifier;
a Monitoring type;
a monitoring area; and
a Mode option set to value PULL.

In an embodiment according to the first aspect, the first message comprises the smart contract.

In an embodiment according to the first aspect, the first response message comprises at least one of the following:
event report for the detected event previously subscribed to by the AF device 101;
information on subscription change related events;
identity of an end-user;
location information of an end-user;
time-stamp related to the detected event;
at least one MNO identifier; and
any other information initially comprised in the smart contract.

In an embodiment according to the first aspect, the at least one NEF device is at least two NEF devices, wherein each NEF device is operated by a different Mobile Network Operator, MNO.

In an embodiment according to the first aspect, the AF device is part of the blockchain network.

In an embodiment according to the first aspect, the AF device comprises a blockchain host performing the method according to the first aspect.

In an embodiment according to the first aspect, the service or the event is monitored by a network function, NF, device;

In an embodiment according to the first aspect, the NF device is one of: Access and Mobility Management Function, AMF or Unified Data Management, UDM.

According to a second aspect, there is provided a method performed by a network exposure function, NEF, device. The method comprises receiving a first notification message notifying about registration of a smart contract, wherein the smart contract is registered on a blockchain network by an application function, AF, device. The method comprises receiving a second notification message notifying about subscription, by the AF device, to an event. The method comprises sending a first response message registering a response notifying about the event.

In an embodiment according to the second aspect, the method further comprises sending a second response message registering a response responsive to receiving the first notification message.

In an embodiment according to the second aspect, the event is a Fifth Generation, 5G, monitoring event or a Sixth Generation, 6G, monitoring event.

In an embodiment according to the second aspect, the 5G monitoring event is at least one of the following events:
User Equipment, UE, reachability,
Location Reporting,
Change of Subscription Permanent Identifier-Permanent Equipment Identifier, SUPI-PEI, association,
Roaming Status,
Number of UEs present in a geographic area, and
UE reachability for Short Message Service, SMS, delivery.

In an embodiment according to the second aspect, when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PULL

In an embodiment according to the second aspect, when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PUSH

In an embodiment according to the second aspect, when the event is Location Reporting, the first response message or the second response message comprises at least one of the following data:
time stamp;
user location information; and
MNO identifier.

In an embodiment according to the second aspect, when the monitoring event is Number of UEs present in a geographic area, the smart contract comprises at least one of the following data:
a Service Capability Server/Application Server, SCS/AS, Identifier;
a Monitoring type;
a monitoring area; and
a Mode option set to value PULL

In an embodiment according to the second aspect, when the monitoring event is Number of UEs present in a geographic area, the first response message or the second response message comprises at least one of the following data:
time stamp;
number of users in an area; and
MNO identifier.

In an embodiment according to the second aspect, the first response message comprises at least one of the following:
event report for the detected event previously subscribed to by the AF device;
information on subscription change related events;
identity of an end-user;
location information of an end-user;
time-stamp related to the detected event;
at least one MNO identifier; and
any other information initially comprised in the smart contract.

In an embodiment according to the second aspect, sending the first response message triggers execution of the smart contract on the blockchain network.

In an embodiment according to the second aspect, the AF device and the NEF device are part of the blockchain network.

In an embodiment according to the second aspect, the NEF device comprises a blockchain host performing the method according to the second aspect.

According to a third aspect, there is provided a method performed by a blockchain network. The method comprises receiving, from an AF device, a first message registering a smart contract on the blockchain network, for accessing a service provided by at least one network exposure function, NEF, device. The method comprises sending, to each of at least one NEF device, a first notification message notifying about the registration of the smart contract, The method comprises receiving, from the AF device, a second message subscribing to notification of an event provided by the at least one NEF device. The method comprises sending, to each of the at least one NEF device, a second notification message notifying subscription, by the AF device, to the event. The method comprises receiving, from the least one NEF device, a first response message registering a response responsive to the first notification message. The method comprises receiving, from at least one NEF device, a second response message registering a response responsive to the second notification message. The method comprises sending, to the AF device, at least one third response message notifying about the event. The method comprises executing the smart contract on the blockchain network responsive to the AF device receiving the third response message.

In an embodiment according to the third aspect, each NEF device is operated by or belongs to a different Mobile Network Operator, MNO.

In an embodiment according to the third aspect, the first response message comprises a confirmation by NEF device on providing the notification of the event.

In an embodiment according to the third aspect, the second response message and the third response message comprises at least one of the following:
event report for the detected event previously subscribed to by the AF device;
information on subscription change related events;
identity of an end-user;
location information of an end-user;
time-stamp related to the detected event;
at least one MNO identifier; and
any other information initially comprised in the smart contract.

According to a fourth aspect, there is provided an application function, AF, device, comprising a memory and processor, the memory containing instructions which when executed on the processor, cause the AF device to send a first message registering a smart contract on a blockchain network, for accessing a service provided by at least one network exposure function, NEF, device; send a second message subscribing to notification of an event provided by the at least one NEF device; and receive at least one first response message notifying about the event wherein receiving the first response message triggers an execution of the smart contract on the blockchain network.

In an embodiment according to the fourth aspect, the memory contains instructions which when executed on the processor, further cause the AF device to send a request for authorizing the AF device to access the service, and receive an authorization response, wherein the authorization response includes one of: an indication that the AF device is authorized or an indication that the AF device is not authorized.

In an embodiment according to the fourth aspect, the memory contains instructions which when executed on the processor, further cause the AF device to perform a method according to any of the embodiments according to the first aspect.

According to a fifth aspect, there is provided a network exposure function, NEF, device, comprising a memory and processor, the memory containing instructions which when executed on the processor, cause the NEF device to receive a first notification message notifying about registration of a smart contract, wherein the smart contract is registered on a blockchain network by an application function, AF, device; receive a second notification message notifying subscription, by the AF device, to an event; and send a first response message registering a response notifying about the event.

In an embodiment according to the fifth aspect, the memory contains instructions which when executed on the processor, further cause the NEF device to send a second response message registering a response responsive to receiving the first notification message.

In an embodiment according to the fifth aspect, the memory contains instructions which when executed on the processor, further cause the NEF device to perform a method according to any of the embodiments according to the second aspect.

According to a sixth aspect, there is provided a computer program comprising instructions which, when executed on an application function, AF, device cause the AF device to carry out a method according to any one of the embodiments according to the first aspect.

According to a seventh aspect, there is provided a computer program product comprising a computer readable storage means on which the computer program according to sixth aspect is stored.

According to an eighth aspect, there is provided a computer program comprising instructions which, when executed on a network exposure function, NEF, device cause the NEF device to carry out the method according to any one of the embodiments according to the second aspect.

According to a ninth aspect, there is provided a computer program product comprising a computer readable storage means on which the computer program according to the eight aspect is stored.

According to a tenth aspect, there is provided a computer program comprising instructions which, when executed on a blockchain network cause the blockchain network to carry out a method according to any one of the embodiments of the third aspect.

According to an eleventh aspect, there is provided a computer program product comprising a computer readable storage means on which the computer program according to the tenth aspect is stored.

One or more advantages of one or more embodiments of the invention are described below:
Controlled and selective access to a service exposed by a network function;
Leverage smart contract and permissioned blockchain for secure data handling and for providing authorization control;
Seamless access to service and monitoring events in a multi-operator or multi-vendor system;
Common interface to access all MNOs' network services;
Smart contract to regulate and track the entire service request and execution process;
Delivering of data related to public safety and/or national security in a integrity and confidentiality protected manner; and
Unified, enhanced and easy to deploy solution for network service exposure, being used, for example, in case of pandemic or other emergency situations.

### BRIEF DESCRIPTION OF THE DRAWINGS

For a better understanding of the disclosure, and to show more readily how it may be carried into effect, reference will now be made, by way of example, to the following drawings, in which:

FIG. 1 illustrates a 5G system architecture with various entities and interfaces.

FIG. 2 illustrates a system consisting of mobile network operators communicating via a blockchain network according to an embodiment.

FIG. 3 illustrates a flow chart according to an embodiment.

FIG. 4a illustrates data comprised in a smart contract according to an embodiment.

FIG. 4b illustrates data comprised in a smart contract according to an embodiment.

FIG. 4c illustrates data comprised in a smart contract according to an embodiment.

FIG. 5 illustrates a method performed by an application function device according to an embodiment.

FIG. 6 illustrates a method performed by a network exposure function device according to an embodiment.

FIG. 7 illustrates an application function device according to an embodiment.

FIG. 8 illustrates a network exposure function device according to an embodiment.

FIG. 9 illustrates a method performed by a blockchain network according to an embodiment.

FIG. 10 illustrates a blockchain host according to an embodiment.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

It is proposed herein the introduction of smart contracts for network service exposure data handling such as 5G network service exposure data handling. The invention proposes controlled and selective access to specified services and/or specified data leveraging on authorization control implemented using a blockchain network such as a permissioned blockchain. The proposed solution enables access to services and related data in multi-operator and/or multi-vendor domain.

Suppose an AF device requires access to one or more MNOs' 5G services exposed in a multi-operator and/or multi-vendor system architecture. In other words, the AF device requires to subscribe to one or more monitoring events exposed by the NEF devices of the MNOs' network. To achieve this, the concept of blockchain technology is leveraged. That is, the AF device registers a smart contract in a blockchain network, e.g. a permissioned blockchain network. In some cases, only an authorized AF device may have access to perform such smart contract registration. Consequently, the NEF devices of the one or more MNOs will receive a notification about the smart contract registration. The NEF devices of the one or more MNOs will further receive a notification of the subscription to event notification by the AF device via the blockchain network. An NEF device of one of the MNOs may provide/expose the event data requested by the AF device. The NEF device may communicate with a network function (NF) of the same MNO in relation to the monitoring event whose notification are requested by the AF device. The execution flow from the NEF device to the other NF devices inside the MNO's infrastructure may be executed according to the standard signaling specified in the Third Generation Partnership Project (3GPP) standard, for example 3GPP TS 23.502 V16.4.0 (2020-03)—Procedures for the 5G System (5GS); Stage 2 (Release 16), as per the service-based 5G architecture. The NEF device of the MNO may then register a response regarding the event in the blockchain network (or the smart contract) and the communicated data may be distributed via the blockchain network. The AF device may receive one or more responses about the event via the blockchain network. The AF device may perform and/or initiate execution of the smart contract on the blockchain network.

The invention, thus, introduces a multi-operator and multi-vendor solution to access MNOs' exposed services by using smart contract and permissioned blockchain network, ensuring secure and authorized accesses to exposed data as well as maintain data integrity and confidentiality.

One or more terminologies used in the present document are described below.

In the present document, the term ‘distributed ledger’ or ‘blockchain’ may refer to any kind of distributed or decentralized ledger that supports one or more smart contracts or smart contract functionality and/or blockchain functionality. The distributed ledger may support the possibility of storing data in a database outside of the distributed ledger while keeping a hash of the data inside the distributed ledger. In case of Hyperledger Fabric, the possibility of storing data in a database outside of the distributed ledger while keeping a hash of the data inside the distributed ledger, is implemented as private data collection. Similarly, in case of Quorum, the possibility of storing data in a database outside of the distributed ledger while keeping a hash of the data inside the distributed ledger, is implemented as private transactions. The implementation may be a native capability or implemented by using the smart contract capabilities or implemented by using blockchain capabilities. The term ‘ledger’ may also be used, herein, to refer to a distributed ledger.

In the present document, the term ‘smart contract’ may refer to a piece of software code invoked by a client application external or internal to a blockchain network wherein the piece of software code manages access to the state of the distributed ledger via a transaction. It may refer to general purpose computation that takes place on a blockchain network or distributed ledger. In other words, a smart contract is computer code that implements a computer protocol intended to digitally facilitate, verify, or enforce the negotiation or performance of a contract. A smart contract is usually written in a human readable language that is then compiled to a machine language before execution. Consensus is achieved, using the ledger protocols, regarding the definition of each smart contract. A smart contract allows the execution of transactions between two entities, e.g., the AF device 101 and the NEF device 1 102 without the involvement of a third party. Once executed, the transactions of a smart contract are stored in a digital ledger and are trackable and irreversible. In this document, the terms “contract” and “smart contract” are used interchangeably, unless otherwise stated.

In the present document, the term ‘transaction’ may refer to a singular input into a blockchain network that affects a change in the blockchain's data. Each transaction in a blockchain is digitally signed by the originator. Each transaction, either singly or in blocks, is chained to a prior transaction via a digital hash wherein a digital hash is an electronic fingerprint of data that is globally unique and extremely difficult to forge. Transaction that are validated are replicated using a consensus algorithm across all machines running the blockchain. For example, in Hyperledger Fabric, transactions are created when a smart contract is invoked from a client application to read or write data from a distributed ledger. As a further example, in cryptocurrency blockchains, each transaction contains a list of digital-currency inputs and outputs, along with metadata, such as a timestamp or optional transaction fee.

In the present document, the term ‘executing a transaction or committing a transaction’ refers to writing or appending a block to a distributed ledger. A block may refer to a single section of discrete data. A block typically comprises a list of transactions or actions to be performed when processing the data in the block. In the present document, ‘registering a smart contract on a blockchain’ may refer to deployment of a smart contract on a blockchain network by sending/committing a transaction from a device (or the device's wallet) for the blockchain network. The transaction may include compiled software code for the smart contract as well as a special receiver address. The transaction may then be included in a block that is added to the blockchain, at which point the smart contract's software code may execute to establish the initial state of the smart contract.

In the present document, ‘end-user’ may refer to an end-user device like a User Equipment (UE) or a user of an end-user device.

In the present document, it may be noted that any reference made to an NEF includes a reference to the NEF device e.g. the NEF device 102 and/or the NEF device x 102n, and any reference made to an AF includes a reference to the AF device 101, unless otherwise stated.

Similarly, any reference made to an NF includes a reference to the NF device, e.g. the NF device 1 or the NF device x.

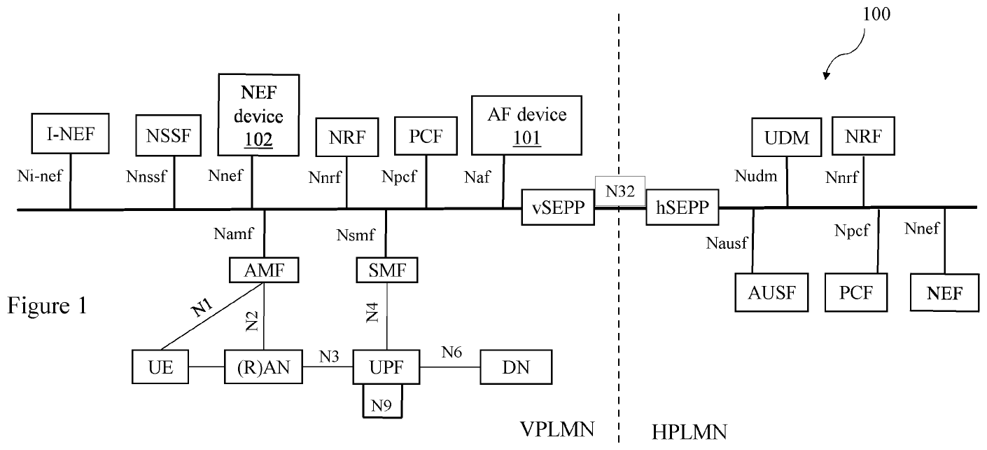

FIG. 1 illustrates a wireless communication system represented as a 5G network architecture composed of core network functions (NFs), using service-based interfaces between the NFs in the control plane.

Seen from the access network side, the 5G network architecture shown in FIG. 1 comprises one or more User Equipment (UEs) connected to either a Radio Access Network (RAN) or an Access Network (AN) as well as an access and mobility management function (AMF). Typically, the R(AN) comprises base stations, e.g., such as evolved node Bs (eNBs) or 5G base stations (gNBs) or similar.

Seen from the core network side, the 5G core NFs in the visitor public land mobile network (vPLMN) shown in FIG. 1 include a network slice selection function (NSSF), a network exposure function (NEF) such as the NEF device 102, an intermediate NEF (I-NEF), a network repository function (NRF), a policy control function (PCF), an application function (AF) such as the AF device 101, an access and mobility management function (AMF), a session management function (SMF), a user plane function (UPF), a data network (DN) and a visitor security edge protection proxy (vSEPP). The 5G core NFs in the home public land mobile Network (HPLMN) shown in FIG. 1 include a home security edge protection proxy (hSEPP), a unified data management (UDM), an authentication server function (AUSF), PCF, NRF and NEF.

FIG. 1 illustrates a 5G network architecture using service-based interfaces between the NFs in the control plane, instead of the point-to-point reference points/interfaces. The service(s) that the NF provides to other authorized NFs may be exposed to the authorized NFs through the service-based interface. In FIG. 1, the service-based interfaces are indicated by the letter “N” followed by the name of the NF, e.g., Namf for the service-based interface of the AMF and Nsmf for the service-based interface of the SMF etc. It should be noted that all NFs depicted in FIG. 1 may interact with the NEF and the NRF.

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. N4 is used by the SMF and UPF so that the UPF may be set using the control signal generated by the SMF, and the UPF may report its state to the SMF. N6 is the reference point for connection between the UPF and the DN. N9 is the reference point for the connection between different UPFs. N14 is a reference point (not shown in FIG. 1) connecting between different AMFs, respectively. There is a reference point, N11, (not shown in the FIG. 1) between the AMF and SMF, which implies that the SMF is at least partly controlled by the AMF. The 5G core network aims at separating user plane and control plane. The user plane carries user traffic while the control plane carries signaling in the network. In FIG. 1, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the round-trip time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF may also be separated. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

Some properties of the NFs shown in FIG. 1 may be described in the following manner. The AMF provides UE-based authentication, authorization, mobility management, etc. A UE even using multiple access technologies is basically connected to a single AMF because the AMF is independent of the access technologies. The SMF is responsible for session management and allocates internet protocol (IP) addresses to UEs. It also selects and controls the UPF for data transfer. If a UE has multiple sessions, different SMFs may be allocated to each session to manage them individually and possibly provide different functionalities per session. The AF, e.g. the AF device 101, provides information on the packet flow to the PCF responsible for policy control in order to support quality of service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The data network (DN), not part of the 5G core network, provides Internet access or operator services and similar. The NEF, e.g. the NEF device 102, supports the following independent functionalities:
Exposure of capabilities and events: NF capabilities and events are securely exposed by NEF for e.g. 3rd party, AFs, edge computing. The NEF stores/retrieves information as structured data using a standardized interface Nudr to a unified data repository (UDR).
Secure provision of information from external application to 3GPP network: The NEF provides a means for the AFs, e.g. the AF device 101, to securely provide information to 3GPP networks, e.g. expected UE behaviour, 5G local area network (5GLAN) group information and service specific information. In that case the NEF may authenticate and authorize and assist in serving the AFs.
Translation of internal-external information: The NEF translates between the information exchanged with the AF and the information exchanged with the internal network function. For example, the NEF translates between an AF-service-identifier and internal 5G Core information such as data network name (DNN), single network slice selection assistance information (S-NSSAI). In particular, NEF handles masking of network and user sensitive information to external AFs according to the network policy.
The NEF receives information from other NFs based on exposed capabilities of other NFs. The NEF stores the received information as structured data using a standardized interface to the UDR. The stored information may be accessed and “re-exposed” by the NEF to other NFs and AFs and used for other purposes such as analytics.
Exposure of analytics: network data analytics function (NWDAF) analytics may be securely exposed by NEF for an external party.
NEF may support a packet flow description (PFD) Function: The PFD Function in the NEF may store and retrieve PFD(s) in the UDR and shall provide PFD(s) to the SMF on the request of SMF (pull mode) or on the request of PFD management from NEF (push mode).
NEF may also support a 5GLAN group management function: The 5GLAN Group Management Function in the NEF may store the 5GLAN group information in the UDR via UDM.
Retrieval of data from external party by NWDAF: Data provided by the external party may be collected by NWDAF via NEF for analytics generation purpose. NEF handles and forwards requests and notifications between NWDAF and AF.
Support of Non-IP Data Delivery: NEF provides a means for management of non-IP data delivery (NIDD) configuration and delivery of mobile originated (MO)/mobile terminated (MT) unstructured data by exposing the NIDD application programming interfaces (APIs) on the N33/Nnef reference point.

A specific NEF instance may support one or more of the functionalities described above and consequently an individual NEF may support a subset of the APIs specified for capability exposure. An external AF may access the services and the monitoring events through the NEF. Each operator has its own exposure function, so if the same request shall be sent to different or all MNOs, the external AF typically send requests to each MNO's NEF separately.

An NF may be implemented either as a network element on a dedicated hardware, as a software instance running on a dedicated hardware, or as a virtualized function instantiated on an appropriate platform, e.g., a cloud infrastructure.

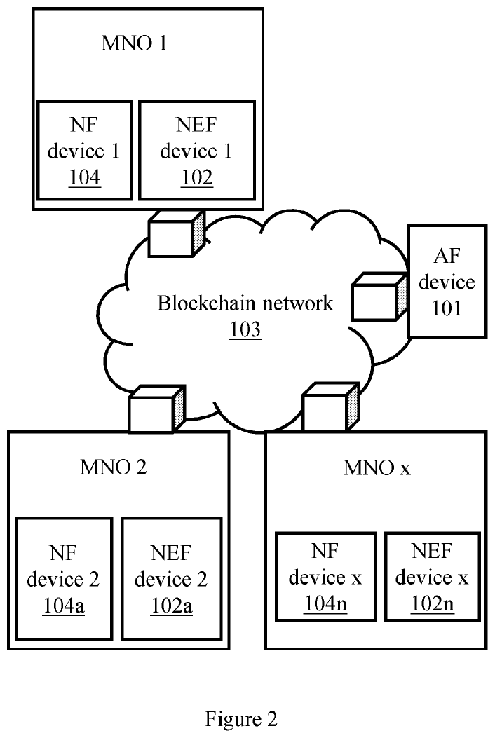

Referring to FIG. 2, an example system architecture is illustrated comprising one or more mobile network operators (for example MNO 1, MNO 2, . . . ) communicating via a blockchain network 103. Each MNO operates and/or owns a mobile network infrastructure comprising an NEF device (for example the NEF device 1 102) and an NF device (for example the NF device 1 104). As such, the NF device, e.g. the NF device 1 104, may comprise the NF functionalities and capabilities as described above in relation to FIG. 1 and/or according to the 3GPP

Standard. For instance, the NF device may include any one of the following network functions' functionalities: AMF, UDM, NSSF, NRF, PCF, SMF, UPF, a DN and vSEPP. Similarly, the NEF device, e.g. the NEF device 1 102, may comprise the NEF functionalities and capabilities according to the 3GPP standard.

Throughout this document, the notation MNO x is used to denote the xth MNO (x being 1,2,3, . . . ). Similarly, the notation NF device x is used to indicate the NF device belonging to or operated by xth MNO (x being 1,2,3, . . . ) and the notation NEF device x is used to indicate the NEF device belonging to xth MNO (x being 1,2,3, . . . ). Further the suffix n used in the number referencing indicates the alphabets a,b, . . . for the (x+1)th MNO (i.e n=a,b, . . . z,aa,ab, . . . for x=2,3, . . . ). For example, the 3^{rd} MNO i.e. MNO 3 operates and/or owns a mobile network infrastructure comprising an NEF device 3 102b and NF device 3 104b. Even though the NEF devices and the NF devices have been denoted with different suffixes 1,2,3, . . . , it is done merely for the sake of readability and it may be noted that, in principle, the different NEF devices (e.g. the NEF device 1 102, NEF device 2 102a, . . . ) and the NF devices (e.g. the NF device 1 104, the NF device 104a, . . . ) may operate similarly in their functions and include similar software and hardware functionalities including implementing the typical NEF and NF functions respectively according to the 3GPP standard.

Referring again to FIG. 2, the blockchain network 103 may include blockchain technology that is based on maintaining a distributed ledger which keeps track of messages exchanged among different entities or devices. A blockchain such as the blockchain network 103 may comprise a continuously extendable list of records, so called blocks, which are linked using cryptographic techniques. Typically, each block contains a cryptographic hash of the previous block in the chain, a timestamp and data. The reading and writing of data on the blockchain may be performed through blockchain-specific libraries. For example, in the Ethereum blockchain, such libraries may be web3 or Metamask. Further, as an example, for Ethereum blockchain, the blockchain client may exchange application layer messages such as JavaScript Object Notation (JSON) over Hypertext Transfer Protocol (HTTP) POST. Further details on specific libraries are beyond the scope of the invention and as such, documentation of these libraries may be easily consulted by someone skilled in the art, for example, to identify the relevant calls to achieve the effect of sending or committing a transaction to the ledger or reading the ledger values at a certain index. There might be several ways of actually storing of the data in the blockchain. For example, the data may be stored in a data field associated to a transaction, or in a private database or as part of a smart contract. It may be appreciated by those skilled in the art that one may choose a blockchain network implementation based on some additional criteria such as cost optimization.

For use as a distributed ledger, the blockchain network 103 is managed by a peer-to-peer network, in which all nodes, for example, the NEF device 1 102, the NEF device x 102n and the AF device 102, may collectively adhere to a protocol for validating new blocks. By design, the blockchain network 103 may inherently be resistant to modification of the data, because, once recorded, the data in any given block may not be altered retroactively without alteration of all subsequent blocks, which would require consensus among the majority nodes in the blockchain network 103. The likelihood of malicious actors altering the data is, thus, very low. Thereby, the use of blockchain network for the purposes of handling 5G service exposure data makes the implementation more secure.

The smart contract is a self-executing contract with the terms of the agreement between a producer device and a consumer device being directly written into lines of software code. The software code and the agreements contained therein exist across a distributed, decentralized blockchain network, e.g. the blockchain network 103. That is, the smart contract is a programmable contract that is capable of automatically enforcing itself when predefined conditions are met. The smart contract executed on the blockchain network 103 may provide trustable data and means to support selective data consuming and, if required, consuming of anonymized data. The smart contract may be structured to orchestrate use cases across different networks. As an example, a location service may be activated in many networks at the same time. Furthermore, at first localization, the smart contract may be terminated in all the networks which were part of the transaction so as to free up valuable network resources.

A permissioned blockchain network, e.g. the blockchain network 103, may be setup with one or more of the following relevant entities or nodes or devices:
Any data-consumers, business services, OTTs etc;
Exposure Functions from one MNO only, e.g. the NEF device 1 102;
Exposure Functions from one or more MNOs (Confederated), e.g. the NEF device 1 102, the NEF device 2 102a and any other NEF device x 102n.

The permissioned blockchain network maintain an access control layer to allow certain actions to be performed only by certain identifiable participants. These blockchains differ from public as well as private blockchains.

Typically, the handling of data in the blockchain network 103 by any device (i.e. writing/reading of data) is disciplined via Electronic Certificates, issued by a Certification Authority. Further, the exposed data from the 5G NFs/NEFs may also be anonymized when accessed from consumer side, e.g. when accessed from the AF device 101. This enables the implementation to be more secure.

It may be noted that the main source of information, e.g. regarding services and/or monitoring events, are the NF devices or the NEF devices. They may, directly or indirectly, provide data that the network manages and exposes. The MNO infrastructure comprising the NF device and/or NEF device may expose the data being part of the permissioned blockchain network such as the blockchain network 103. More than one MNO may expose data via the blockchain network 103, in such cases the MNOs may have mutual agreements. Additionally, the one or more data consumers applications, e.g. the AF device 101 applications, may access and consume data from the one or more MNOs' network as disciplined by their authorization to data accesses.

It may be noted that, in one or more embodiments, the AF device 101 and the NEF devices 102, 102a belonging to the different MNOs, are not directly part of the blockchain network 103. Instead, the AF device 101 and NEF devices 102, 102a may interact with hosts on the blockchain network 103 via software agents installed on the devices. The AF device 101 and NEF devices may, thus, communicate data/event notifications regarding the monitoring events and services while the smart contract itself may be executed on the blockchain hosts part of the blockchain network 103.

In one or more embodiments, the AF device 101 and the NEF devices 102, 102a belonging to different MNOs are directly part of the blockchain network 103. That is, the AF device 101 and NEF devices 102, 102a are blockchain hosts executing the smart contract while also communicating the data/event notifications regarding the monitoring events and services.

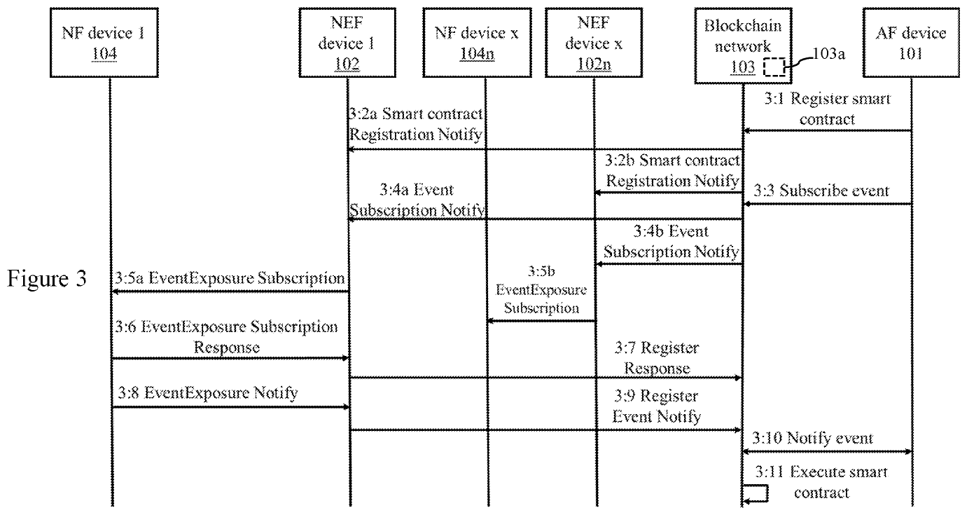

FIG. 3 illustrates a signal flowchart between various entities according to an embodiment. More specifically, the FIG. 1 depicts the interaction between the AF device 101, the blockchain network 103, the NEF devices i.e. the NEF device 1 102 and the NEF device x 102n and the NF devices, i.e. the NF device 1 104 and the NF device x 104n.

The AF device 101 creates a smart contract for receiving one or more monitoring events related to a specific end-user and registers the smart contract on the blockchain network 103. The NEF device of the MNOs are notified about the registration of the smart contract via the blockchain network 103. The AF device 101 subscribes to notifications about the one or more monitoring events. The NF device of each MNO monitors and detects the monitoring event and sends an event report to their respective NEF devices. The NEF devices each belonging to different MNOs register, on the blockchain network 103, information about the detected event and/or information about the end-user. The AF device 101 receives notification about the detected event either via a PULL mode or a PUSH mode of operation. The AF device 101 may further use the information about the detected events, for example, for executing applications related to public safety.

It may further be noted that the steps illustrated in FIG. 3 namely Arrows 3:1 to Arrow 3:11 may be executed as part of the same transaction.

FIG. 3 will now be described in further detail.

### Arrow 3:1—Register Smart Contract

The AF device 101 may want to access at least one service provided by at least one MNO's NEF device. For instance, the AF device 101 may want to access a service A provided/exposed by NEF device 1 102 belonging to MNO 1 and/or a service B provided/exposed by NEF device 2 102a belonging to MNO 2. For this purpose, the AF device 101 may register a smart contract with the blockchain network 103. In other words, the AF device 101 sends a first message registering the smart contract on the blockchain network 103 for accessing the service(s) exposed by one or more MNOs' NEF devices. Further, the AF device 101 may send the first message registering the smart contract on the blockchain network 103 for subscribing to notification of one or more monitoring events. The monitoring event may be monitored by an NF device, e.g. NF device 1 104, and the monitoring event data may be exposed via the NEF device, e.g. the NEF device 1 102.

The AF device 101 may register the smart contract on the blockchain network 103 wherein the smart contract is replicated among all participating devices on the blockchain network 103. The participating devices may, for example, be one or more MNOs' NEF devices.

The AF device 101 may register the smart contract using APIs via a blockchain network such as Ethereum. The reading and writing of data on the blockchain network may be performed through blockchain-specific libraries. For example, in the Ethereum blockchain, such libraries may be web3 or Metamask. Further, as an example, for Ethereum blockchain, the AF device 101 may exchange application layer messages such as JSON over HTTP POST.

As a further example, the AF device 101 may register the smart contract using a framework such Open Liberty.

The AF device 101 may want to get notification of one or more events that are exposed as services by the one or more MNOs' NEF devices and use that information for applications like those of public safety. The exposed service may relate to accessing MNOs' capabilities as well as related information when a User Equipment (UE) is available in the network. Table 1 illustrates an example list of monitoring events that are exposed as services, for example by the NEF device 102, as described for example in 3GPP TS 29.122 v 17.6.0 (2022-06).

TABLE 1
Example list of monitoring events exposed as services

| Enumeration value | Description | Applicability |
|---|---|---|
| LOSS_OF_CONNECTIVITY | The service capability server (SCS)/ | Loss_of_connectivity_{—} |
| | application server (AS), e.g. the AF device | notification |
| | 101, requests to be notified when the 3GPP | |
| | network detects that the UE is no longer | |
| | reachable for signalling or user plane | |
| | communication. | |
| UE_REACHABILITY | The SCS/AS, e.g. the AF device 101, | Ue- |
| | requests to be notified when the UE | reachability_notification |
| | becomes reachable for sending either SMS | |
| | or downlink data to the UE. | |
| LOCATION_REPORTING | The SCS/AS, e.g. the AF device 101, | Location_notification, |
| | requests to be notified of the current | eLCS |
| | location or the last known location of the | |
| | UE. | |
| CHANGE_OF_IMSI_{—} | The SCS/AS, e.g. the AF device 101, | Change_of_IMSI_IMEI_{—} |
| IMEI_ASSOCIATION | requests to be notified when the association | association_notification |
| | of a mobile equipment (International | |
| | Mobile Equipment Identity (IMEI(SV))) | |
| | that uses a specific subscription | |
| | International Mobile Subscriber Identity | |
| | (IMSI) is changed. | |
| ROAMING_STATUS | The SCS/AS, e.g. the AF device 101, | Roaming_status_{—} |
| | queries the UE's current roaming status and | notification |
| | requests to get notified when the status | |
| | changes. | |
| COMMUNICATION_{—} | The SCS/AS, e.g. the AF device 101, | Communication_failure_{—} |
| FAILURE | requests to be notified of communication | notification |
| | failure events. | |
| AVAILABILITY_AFTER_{—} | The SCS/AS, e.g. the AF device 101, | Availability_after_{—} |
| DDN_FAILURE | requests to be notified when the UE has | DDN_failure_notification, |
| | become available after a downlink data | Availability_after_{—} |
| | notification (DDN) failure. | DDN_failure_notification_{—} |
| | | enhancement |
| NUMBER_OF_UES_IN_{—} | The SCS/AS, e.g. the AF device 101, | Number_of_UEs_in_an_{—} |
| AN_AREA | requests to be notified the number of UEs in | area_notification, |
| | a given geographic area. | Number_of_UEs_in_an_{—} |
| | | area_notification_5G |
| PDN_CONNECTIVITY_{—} | The SCS/AS, e.g. the AF device 101, | Pdn_connectivity_status |
| STATUS | requests to be notified when the 3GPP | |
| | network detects that the UE's packet data | |
| | network (PDN) connection is set up or torn | |
| | down. | |
| DOWNLINK_DATA_{—} | The AF, e.g. the AF device 101, requests to | Downlink_data_delivery_{—} |
| DELIVERY_STATUS | be notified when the 3GPP network detects | status_5G |
| | that the downlink data delivery status is | |
| | changed. | |
| API_SUPPORT_{—} | The SCS/AS, e.g. the AF device 101, | API_support_capability_{—} |
| CAPABILITY | requests to be notified of the availability of | notification |
| | support of service APIs. | |
| NUM_OF_REGD_UES | The AF, e.g. the AF device 101, requests to | NSAC |
| | be notified of the current number of | |
| | registered UEs for a network slice. | |
| NUM_OF_ESTD_PDU_{—} | The AF, e.g. the AF device 101, requests to | NSAC |
| SESSIONS | be notified of the current number of | |
| | established packet data unit (PDU) Sessions | |
| | for a network slice. | |
| AREA_OF_INTEREST | The SCS/AS, e.g. the AF device 101, | UAV |
| | requests to be notified when the unmanned | |
| | air vehicle (UAV) moves in or out of the | |
| | geographic area. | |

Table 2 describes an additional example list of monitoring events and their detection criteria exposed by one or more MNOs' NEF devices.

TABLE 2
Example list of monitoring events and their detection criteria

| | | Which NF |
|---|---|---|
| | | detects the |
| Event | Detection criteria | event |
| UE | Detected when the UE transitions to CM-CONNECTED | AMF, UDM |
| reachability | state or when the UE will become reachable for paging, | |
| | e.g., Periodic Registration Update timer. It indicates when | |
| | the UE becomes reachable for sending downlink data to | |
| | the UE. | |
| | The AF, e.g. the AF device 101, may provide the following | |
| | parameters: | |
| | 1) Maximum Latency; | |
| | 2) Maximum Response Time; | |
| | 3) Suggested number of downlink packets. | |
| Location | This event is detected based on the Event Reporting | AMF, |
| Reporting | information parameters that were received in the | GMLC |
| | monitoring request (one-time reporting, maximum number | |
| | of reports, maximum duration of reporting, periodicity, | |
| | etc.) | |
| | It indicates either the Current Location or the Last Known | |
| | Location of a UE. | |
| | When AMF is the detecting NF device: | |
| | One-time and Continuous Location Reporting are | |
| | supported for the Current Location. For Continuous | |
| | Location Reporting the serving node(s) sends a | |
| | notification every time it becomes aware of a location | |
| | change, with the granularity depending on the accepted | |
| | accuracy of location. For Last Known Location only One- | |
| | time Reporting is supported. | |
| | When gateway mobile location centre (GMLC) is the | |
| | detecting NF device: | |
| | Immediate and Deferred Location Reporting is supported. | |
| | For Deferred Location Reporting the event types UE | |
| | availability, area, periodic location and motion are | |
| | supported. | |
| Change of | This event is detected when the association between | UDM |
| SUPI-PEI | Permanent Equipment Identifier (PEI) and Subscription | |
| association | Permanent Identifier (SUPI) subscription changes (USIM | |
| | change). | |
| Roaming | This event is detected when the UE's current roaming | UDM |
| status | status (the serving PLMN and/or whether the UE is in its | |
| | HPLMN) and notification when that status changes. | |

Referring to Tables 1 and 2, the UE reachability monitoring event may, for example, be used in case of attempt to search missing people. As soon as the AS, e.g. the AF device 101, gets the notification of a UE being reachable, the AS may initiate a call to reach the UE or initiate a location request.

The Location Reporting monitoring event may be used in different cases, for example attempt to search missing people or track coronavirus disease (COVID-19) positive people.

The Change of SUPI-PEI association monitoring event may, for example, be used to keep up-to-date user register information.

The Roaming Status monitoring event may be used in different cases, for example, to monitor people movements across country borders in case of emergencies.

It may be noted that the above-listed monitoring events of Tables 1 and 2 as such describe example use cases of the monitoring events according to one or more embodiments and shall not be construed in a limiting way as the only possible use cases.

Table 3 describes examples of additional services that may be used by the national authorities in critical situations.

TABLE 3
Example services that may be used by national authorities.

| | Example | |
|---|---|---|
| Service Name | Consumer(s) | Note |
| Nnef_EventExposure | AF, NWDAF | The consumer subscribes to receive an event |
| Nnef_ParameterProvision | UE | This service is for allowing external party to |
| service | | provision information which may be used for |
| | | the UE in 5GS. |
| Nnef_ECRestriction | AF | This service is for allowing the AF, e.g. the AF |
| | | device 101, to query status of Enhanced |
| | | Coverage Restriction or enable/disable |
| | | Enhanced Coverage Restriction per individual |
| | | UE. |

The AF device 101 may register one or more events and services depending on a business scope.

The monitoring events (for example as described in Table 1 and Table 2) and the services (for example as described in Table 3) may be part of the same or different smart contact. An event may be related to a specific service. A service may be associated with one or more events. An event may have a corresponding service associated with it.

In an embodiment, the same service is exposed by each MNO's NEF device. In this case, the AF device 101 registers the smart contract for accessing the same service exposed by each MNO's NEF device.

In an embodiment, different services are exposed by the MNOs' NEF devices. In this case, the AF device 101 registers the smart contract for accessing different services exposed by the NEF devices each belonging to the different MNOs. For example, the AF device 101 registers the smart contract for accessing: a service A provided by the NEF device 102 belonging to MNO 1; a service B provided by the NEF device 2 102a of MNO 2; and a service C provided by the NEF device 3 102b of MNO 3.

In an embodiment, an NEF device belonging to an MNO exposes the complete list of services as described above in Table 1. In some other embodiments, an NEF device belonging to an MNO exposes only a subset of list of services as described above in Table 1.

In some embodiments, the exposure of a service by the NEF device of the MNO depends on the local regulations of the geographic area of operation. For example, the local regulation may mandate the exposure of location-based services for public safety applications.

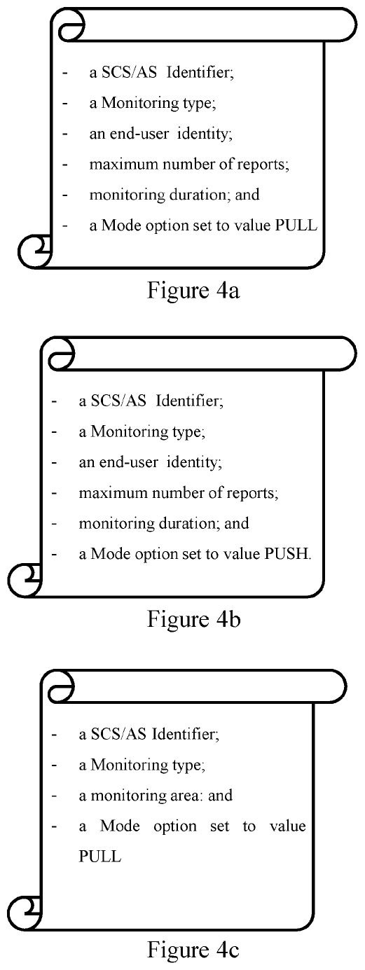

In one or more embodiments, the first message registering the smart contract comprises the smart contract. The smart contract may comprise data depending on the monitoring event, as will be described later in the application with respect to FIGS. 4a, 4b and 4c.

The blockchain network 103 may allow only for authorized entities to register the smart contract on the blockchain network 103. For this reason, in one or more embodiments, the AF device 101 further sends a request message comprising a request for authorizing the AF device 101 to access the one or more services provided by at least one NEF device. The request message may, for example, be sent to a blockchain host 103a operating on/as part of the blockchain network 103. The AF device 101 may further receive a response message comprising an authorization response. The authorization response may be received from a blockchain host 103a on the blockchain network 103. In some embodiments, the authorization response includes an indication that the AF device 101 is authorized or not authorized to register the smart contract. In some embodiments, the authorization response includes a request for further information from the AF device 101 before the blockchain network 103 takes a decision on providing the authorization to the AF device 101. The requested information may, for example, be a security certificate of the AF device 101.

In one or more embodiments, a Role-based Authorization Control (RBAC) authorization procedure based on certificate exchange or token exchange is employed for authorizing the AF device 101.

In one or more embodiments, a Task-based Authorization Control (TBAC) authorization procedure based on certificate exchange or token exchange is employed for authorizing the AF device 101.

In one or more embodiments, the blockchain host 103a is the NEF device, e.g. the NEF device 1 102, operating as part of the blockchain network 103.

In one or more embodiments, the blockchain host 103a is the AF device, e.g. the AF device 101, operating as part of the blockchain network 103.

In one or more embodiments, the blockchain host 103a is a ledger peer of the device such as the NEF device or the AF device 101 operating as part of the blockchain network 103. For example, a ledger peer of the NEF device 1 102. The ledger peer may act on behalf of the NEF device (e.g. the NEF device 1 102, the NEF device x 102n), the AF device 101 or the MNO for blockchain related operations. The ledger peer is typically a software program or process used to take part in the distributed ledger or blockchain network 103 operations. A ledger peer may commit a transaction to the distributed ledger or perform message exchanges with other devices. There may, for example, be one or more ledger peers associated with the NEF device. The blockchain host 103a may further include a database (called as private database) attached to the ledger peer The database may store data for which an integrity record has been inserted into the distributed ledger. The database may, for example, store data related to 5G service exposure functions and/or 6G service functions.

The blockchain host 103a may additionally include a ledger client. The ledger client may be a software program or process through which the NEF device 102, 102a or the AF device 101 interacts with a distributed ledger via a connection with a peer.

In general, the AF device 101 may register the smart contract for accessing one or more services provided by one or more MNOs. This has an advantage that it enables access to all operators' network services via an interface of the smart contract. Further, using the smart contract there is enabled a mechanism to regulate and track the entire service request and execution process.

Arrows 3:2a and 3:2b—Smart contract Registration Notify

Once the AF device 101 registers the smart contract on the blockchain network 103, the one or more NEF devices, e.g. the NEF device 1 102, the NEF device 2 102a, are notified of the registration. The one or more NEF devices, e.g. the NEF device 1 102, the NEF device 2 102a, may be notified via a message sent via the blockchain host 103a, for example as mentioned above with respect to Arrow 3:1. The one or more NEF devices (e.g. the NEF device 1 102, the NEF device 2 102a) may be notified about the smart contract registration on the blockchain network 103, for example, using an open source framework such as Open Liberty. It will further be appreciated that the one or more NEF devices (e.g. the NEF device 1 102, the NEF device 2 102a) may query and listen for a notification about the registration of the smart contract on the blockchain network 103 using one or more existing blockchain frameworks.

In an embodiment, the one or more NEF devices, e.g. the NEF device 1 102, the NEF device 2 102a, are notified of the registration of the smart contract via Open Liberty framework.

The one or more NEF devices (e.g. the NEF device 1 102, the NEF device 2 102a) may be notified about the smart contract registration on the blockchain network 103 using APIs via a blockchain network such as Ethereum. The reading and writing of data on the blockchain network 103 may be performed through blockchain-specific libraries. For example, in the Ethereum blockchain, such libraries may be web3 or Metamask. Further, as an example, for Ethereum blockchain, the one or more MNOs' NEF devices may exchange application layer messages such as JSON over HTTP POST.

The one or more MNOs' NEF devices (e.g. the NEF device 1 102, the NEF device 2 102a), may additionally be notified of the smart contract comprised in the registration message.

### Arrow 3:3—Subscribe Event

The AF device 101 sends a request message for subscribing to notification of one or more events. The AF device 101 may for example send the request message to the blockchain host 103a operating on the blockchain network 103.

In one or more embodiments, the request message comprises the one or more events for which event notification are to be subscribed.

In one or more embodiments, the request message comprises a selection of an event for which event notification is to be subscribed from among the list of events initially registered in the smart contract.

In one or more embodiments, the AF device 101 updates the smart contract with the one or more events to be subscribed, by sending the request message.

The AF device 101 may, for example, use an open source framework such as Open Liberty to send the request message for subscribing to notification of one or more events.

The AF device 101 may send the request message for subscribing to notification of one or more events using APIs via the blockchain network 103 such as Ethereum. The reading and writing of data on the blockchain network may be performed through blockchain-specific libraries. For example, in the Ethereum blockchain, such libraries may be web3 or Metamask. Further, as an example, for Ethereum blockchain, the AF device 101 may exchange application layer messages such as JSON over HTTP POST.

The request message is propagated on the blockchain network 103 to the one or more MNOs' NEF devices, e.g. the NEF device 1 102 or the NEF device x 102n, that are exposing or providing the one or more services and/or the one or more events. The event may for example, be the monitoring event as described in Table 1.

In an embodiment, the event is a Fifth Generation, 5G, monitoring event or a Sixth Generation, 6G, monitoring event.

The 5G monitoring event may, for example be one or more of the following:
UE reachability,
Location Reporting,
Change of SUPI-PEI association,
Roaming Status,
Number of UEs present in a geographic area and
UE reachability for Short Message Service (SMS) delivery.
   Arrows 3:4a and 3.4b—Event Subscription Notify

One or more MNOs' NEF devices, e.g. the NEF device 1 102 and/or the NEF device x 102n, receive from the AF device 101 via the blockchain network 103, the request message comprising the request for subscribing to notification of one or more monitoring events. The one or more NEF devices may be notified of the request message sent via the blockchain host 103a, for example as mentioned above with respect to Arrow 3:1.

Upon receiving the request for subscription, the one or more MNOs' NEF devices may further obtain information comprised in the smart contract that was initially registered by the AF device 101, to identify which monitoring events or services have been requested for subscription. Alternately, the request message may comprise information on which monitoring events or services have been requested for subscription.

Arrows 3:5a and 3.5b—EventExposure Subscription

The one or more MNOs' NEF devices send to NF devices belonging to their respective MNOs' network, e.g. the NF device 1 104 and/or the NF device x 104n, a request message. The request message may comprise a request for subscription, by the AF device 101, to notification of the one or more events/services provided by the NF device. The request message may further comprise a set of event IDs, each event ID identifying an event, subscribed to by the AF device 101. The event IDs may further be the same ones as comprised in the smart contract initially registered by the AF device 101.

The request message that is sent may vary depending on the NF device's functionality. In an embodiment, wherein the NF device is an AMF, the message is a Namf_EventExposure_Subscribe request message. In another embodiment, wherein the NF device is a UDM, the message is a Nudm_EventExposure_Subscribe request message. Further information regarding the AMF service operations and the UDM service operations may be found in, for example, 3GPP TS 23.502 V17.5.0 (2022-06), Sections 4.15.3.2.1 and 4.15.3.2.2 respectively. Although the procedure illustrated by arrow 3:5a and 3:5b has been described with respect to the Subscribe operation of the NEF device, it will be appreciated that the procedure applies in a similar manner to the Unsubscribe operation of the NEF device. The Unsubscribe operation is used to unsubscribe from the notification to one or more monitoring events.

The one or more events or services may be provided by the NF device of an MNO via the NEF device belong to the same MNO. The event may for example, be the monitoring event as described in Table 1. The event may for example, be the 5G monitoring event or 6G monitoring event as described above in relation to arrow 3:3.

The message flow from the NEF device to the NF device within the MNO's network is executed according to the standard signaling procedures specified in, for example, 3GPP TS 23.502 V17.5.0 (2022-06).

### Arrow 3:6—EventExposure Subscription Response

At least one of the MNOs' NF devices, may respond or not respond to the request for subscription to notification of monitoring events/services requested by the AF device 101.

This is explained with an example, as illustrated in FIG. 3. Suppose that a request for the subscription to event notification is in relation to a service provided (or a monitoring event detected) by the NF device 1 104 of MNO 1 only and is not a service provided (or a monitoring event detected) by the NF device x 104n of MNO x. In this case, the NF device 1 104 responds to the subscription request by sending a subscription response message. The response may, for example, be that the NF device 1 104 acknowledges or confirms the subscription to the event notification. However, the NF device x 104n, does not respond to the subscription request as the NF device x 104n does not provide or expose the service (or detect a monitoring event) information which has been requested by the AF device 101. Note that, to depict this example scenario, the FIG. 3 does not include an arrow from the NF device x 104n to the NEF device x 102n.

Thus, only the NEF/NF devices that expose a particular service or detect/monitor a particular event that have been requested by the AF device 101 in the smart contract, send the subscription response message. This has an advantage that unnecessary signaling towards a particular NF device not exposing a requested service is avoided, thereby enabling an efficient communication system.

The request for subscription to event notification may relate to the request made by the AF device 101 in the smart contract via the blockchain network 103.

In one or more embodiments, one or more of the NF devices each belonging to different MNOs respond to the AF device 101 via the blockchain network 103, that a subscription to event notification may not be provided or is denied.

In one or more embodiments, one or more of the NF devices each belonging to different MNOs deny a request to the subscription to event notification due to the AF device 101 not being authorized.

In one or more embodiments, one or more of the NF devices each belonging to different MNOs deny a request to the subscription to event notification due to event data not being available.

The subscription response message may vary depending on the NF device's functionality. In an embodiment, wherein the NF device is an AMF, the subscription response message is a Namf_EventExposure_Subscribe response message. In another embodiment, wherein the NF device is a UDM, the subscription response message is a Nudm_EventExposure_Subscribe response message. Further information regarding the AMF service operations and the UDM service operations may be found in, for example, 3GPP TS 23.502 V17.5.0 (2022-06), Sections 4.15.3.2.1 and 4.15.3.2.2 respectively.

Although the procedure illustrated by arrow 3:6 has been described with respect to the Subscribe operation of the NEF device, it will be appreciated that the procedure applies in a similar manner to the Unsubscribe operation of the NEF device. The Unsubscribe operation is used to unsubscribe from the notification to one or more monitoring events.

The NF device, e.g. the NF device 1 104, thus responds by sending a subscription response message comprising an event subscription response to the NEF device, e.g. the NEF device 1 102.

### Arrow 3:7—Register Response

One or more MNOs' NEF devices, e.g. the NEF device 1 102 belonging to or operated by MNO 1, send to the blockchain network 103, a registration response message. That is, as illustrated by arrow 3:7, the NEF device 1 102 sends a message registering the response of the NEF device 1 102 to the request for subscription to event notification made by the AF device 101.

The registration response message may for example, confirm the subscription to the event notification.

In an embodiment, the registration response message includes an indication denying the subscription to the event notification. In an embodiment, the response includes an indication accepting the subscription to the event notification.

In an embodiment, the registration response message comprises the one or more event IDs that have been confirmed as being subscribed.

The one or more NEF devices may register the response in the smart contract via the registration response message.

The registration response message may comprise the data related to the subscription to the event notification. The one or more MNOs' NEF devices may further store the data on the blockchain network 103. The one or more MNOs' NEF devices may store the data in a private database associated with the blockchain network 103.

The data may, for example, be one or more of the following:
a session identifier related to a transaction;
one or more monitoring event identifiers; and
MNO identifier(s) of MNO(s) that have confirmed subscription to the service or monitoring event;

The one or more MNOs' NEF devices may, for example, use an open source framework such as Open Liberty to send the registration response message.

The one or more MNOs' NEF devices may send the registration response message using APIs via the blockchain network 103 such as Ethereum. The reading and writing of data on the blockchain network may be performed through blockchain-specific libraries. For example, in the Ethereum blockchain, such libraries may be web3 or Metamask. Further, as an example, for Ethereum blockchain, the one or more MNOs' NEF devices may exchange application layer messages such as JSON over HTTP POST.

### Arrow 3:8—EventExposure Notify

When an event is detected, the NF device, e.g. the NF device 1 104, notifies the NEF device 1 102 about the detected event. In other words, the NF device sends to the NEF device a message notifying that the event is detected.

Typically, one or more MNOs' NEF devices that have confirmed to the AF device 101 the subscription to event notification, may be notified of the event detection by their respective MNOs' NF devices.

The detected event may, for example, be the same monitoring event that the AF device 101 initially subscribed to, via the smart contract registered on the blockchain network 103. The monitoring event or the detected event may for example, be any of the events described above in relation to Table 1 and 2. The monitoring event may for example be a 5G monitoring event or a 6G monitoring event.

The NF device, e.g. the NF device 1 104, may include an event report in the message notifying about the event detection. Further, depending on the event, the NF device may detect that a subscription change related event occurs, e.g. Subscription Correlation ID change due to the NF device reallocation, and may send the event report to the NEF device, e.g. NEF device 1 102.

The message notifying the NEF device about the detected event may vary depending on the

NF device's functionality. In an embodiment, wherein the NF device is an AMF, the message is a Namf_EventExposure_Notify message. In another embodiment, wherein the NF device is a UDM, the message is a Nudm_EventExposure_Notify message. Further information regarding the AMF service operations and the UDM service operations may be found in, for example, 3GPP TS 23.502 V17.5.0 (2022-06), Sections 4.15.3.2.1 and 4.15.3.2.2 respectively.

The NEF device, e.g. the NEF device 1 102, receives from the NF device, e.g. the NF device 1 104, the message notifying that the monitoring event is detected.

### Arrow 3:9—Register Event Notify

Typically, one or more MNO's NEF devices that have confirmed to the AF device 101 the subscription to event notification, register the notification of the event detection in the smart contract on the blockchain network 103. In other words, one or more MNOs' NEF devices may register the notification regarding the event detection on the blockchain network 103. The registering of the notification may include at least one of: registering an event report for the detected event on the blockchain network 103; registering subscription change related events; registering the monitored end-user's information like end-user identity, location information, time-stamp; registering the MNO information like MNO identifier.

Furthermore, one or more MNOs' NEF devices may register the information that had initially been requested in the smart contract by the AF device 101. Further details on the information/data comprised in the smart contract will be described later in the application.

The one or more MNOs' NEF devices may, for example, use an open source framework such as Open Liberty to register the notification of the event detection.

The one or more MNOs' NEF devices register the notification of the event detection using APIs via the blockchain network 103 such as Ethereum. The reading and writing of data on the blockchain network may be performed through blockchain-specific libraries. For example, in the Ethereum blockchain, such libraries may be web3 or Metamask. Further, as an example, for Ethereum blockchain, the one or more MNOs' NEF devices may exchange application layer messages such as JSON over HTTP POST to register the notification of the event detection.

### Arrow 3:10—Notify Event

The blockchain network 103 sends an event notification response message to the AF device 101 notifying about the detection of the monitored event. It may be that the blockchain host 103a on the blockchain network 103, as described above in relation to arrow 3:1, sends the event notification response message to the AF device 101 notifying about the detection of the monitored event. In more detail, the blockchain network 103 notifies the AF device 101 regarding the registration, by the one or more MNOs' NEF devices, of the notification of event detection.

The notification regarding the detected event, which event was previously subscribed to by the AF device 101, may, for example, indicate that the event is detected and the event report for the detected event is available on the blockchain network 103.

In one or more embodiments, the event notification response message includes the information registered on the blockchain network 103 by the one or more MNOs' NEF devices, for example, as described above in relation to arrow 3:9.

In one or more embodiments, the event notification response message comprises at least one of the following:
event report for the detected event previously subscribed to by the AF device 101;
information on subscription change related events;
end-user's information like end-user identity, location information, time-stamp;
MNO information like MNO identifier; and
any other information initially comprised in the smart contract.

It may be noted the arrow 3:10 illustrates the blockchain network 103 (or the blockchain host 103a) notifying the AF device 101 of the event detection. This mechanism of obtaining information may be referred to as PUSH mode. In some alternate embodiments, the AF device 101 instead queries the blockchain network 103 (or the blockchain host 103a) regarding a registration of event detection by any of the MNO's NEF devices and further obtains information about the detected event. This mechanism of retrieving information may be referred to as PULL mode.

### Arrow 3:11—Execute Smart Contract

The smart contract being self-executing, is executed on the blockchain network 103 upon a condition of the smart contract agreement being met and/or verified. In this case, the condition of the agreement is, for example, for the AF device 101 to receive notification and/or information about an event detection from the NEF device of at least one MNO. In other words, receiving the response message notifying about the event detection may trigger an execution of the smart contract on the blockchain network 103.

In an embodiment wherein the AF device 101 and the one or more MNOs' NEF devices are directly part of the blockchain network 103, the smart contract is self-executed on the AF device 101 and the NEF devices upon a condition of the smart contract agreement being met.

In an embodiment wherein the AF device 101 and the one or more MNOs' NEF devices are not directly part of the blockchain network 103 but instead communicate with blockchain hosts part of the blockchain network 103, the smart contract is self-executed on the blockchain hosts upon a condition of the agreement being met.

The AF device 101 may further use the information about the detected event for executing applications related to national safety and public security, for example in case of a pandemic situation or an emergency situation.

Hereby, is enabled by one or more embodiments of the invention a unified, enhanced and easy to deploy solution for network service exposure in a multi-MNO environment, being used especially for national safety and public security applications. The invention also enables execution of exposed services including secure delivery of exposed event data while preserving integrity and confidentiality.

Now referring to FIGS. 4a, 4b and 4c, is described a smart contract according to one or more embodiments. The smart contract registered on the blockchain network 103 may include information relating to one or more monitoring events and/or information of an end-user whose events are to be monitored by at least one NF device belonging to an MNO, as will be described below.

FIG. 4a illustrates a smart contract for the monitoring event for Location Reporting in a PULL mode of operation, according to an embodiment.

The AF device 101 creates the smart contract for receiving the monitoring event for Location Reporting related to a specific end-user, the smart contract including one or more of the following information:
Service Capability Server/Application Server (SCS/AS) Identifier;
Monitoring Type (e.g. LOCATION_REPORTING);
The end-user identity (e.g. MSISDN);
Maximum number of Reports;
Monitoring duration; and
The PULL mode option is enabled.

The NEF device of all the MNOs are notified about the registration of the smart contract via the blockchain network 103.

One or more MNOs' NF devices may monitor and detect the monitoring event and send an event report to their respective NEF devices. The NEF devices of the one or more MNOs may register on the blockchain network 103 or in a private database of the blockchain network 103, one or more of the following information about the end-user whose event is monitored by the respective NF devices:
List of end-user location information including:
   Time stamp;
   User information;
   location information (i.e. cell identity); and
   MNO identifier.

The one or more NEF devices may further register on the blockchain network 103, an event report for the detected/monitored event.

In an embodiment, when no information is available in a certain MNO's domain, then it is explicitly communicated to and/or registered in the blockchain network 103 that no information is available in that MNO for the end-user.

According to the PULL mode of operation, the AF device 101 may first receive a notification about the event detection via a response message. In this case, the response message may not comprise the data regarding the detected event. The AF device 101 may then perform: accesses to the blockchain network 103 regarding data (e.g. notification of the monitored/detected event) registered by one or more MNOs' NEF devices; verifies the data availability; and reads the data. This is an example implementation of arrow 3:10 FIG. 3. The data may be the data registered in the blockchain network 103 in relation to the detected/monitored event Location Reporting or, for example, as described above in relation to arrow 3:9 of FIG. 3.

FIG. 4b illustrates the data comprised in the smart contract for monitoring Event for Location Reporting in the PUSH mode of operation, according to an embodiment.

The procedure is similar to that described with respect to FIG. 4a, however with at least one difference that the AF device 101 creates the smart contract comprising a PUSH mode option.

The AF device 101 creates the smart contract for receiving the monitoring event for Location Reporting related to a specific end-user, the smart contract including one or more of the following information:
SCS/AS Identifier;
Monitoring Type (e.g. LOCATION_REPORTING);
The end-user identity (e.g. MSISDN);
Maximum Number of Reports;
Monitoring Duration; and
The PUSH Mode option is enabled.

The one or more MNOs' NF devices may monitor and detect the event and send an event report to their respective NEF devices. The NEF devices of the one or more MNOs may register, on the blockchain network 103 or in a private database of the blockchain network 103, one or more of the following information about the end-user whose event is monitored by the respective NF devices:
List of end-user location information including:
   Time stamp;
   User information;
   location information (i.e. cell identity); and
   MNO identifier.

The one or more NEF devices may further register on the blockchain network 103, an event report for the detected event.

According to the PUSH mode of operation, once the data about the detected event is registered on the blockchain network 103 by the one or more MNOs' NEF devices, the notification regarding the event detection and the data are directly sent from the blockchain network 103 to the AF device 101 via a response message. This is an example implementation of arrow 3:10 of FIG. 3. In other words, the response message notifying about the event detection comprises the data regarding the monitored or detected event. The data may, for example, be the event report for the Location reporting event.

FIG. 4c illustrates the data comprised in the smart contract for monitoring event for Number of UEs in a Geographical Area in the PULL mode, according to an embodiment.

The AF device 101 creates the smart contract for receiving the monitoring event for location reporting related to a specific end-user including the following information:
SCS/AS Identifier;
Monitoring Type (e.g. NUMBER_OF_UES_IN_AN_AREA);
The monitored area (e.g. WGS84 coded shapes, coordinates of polygon); and
The PULL Mode option is enabled.

The NEF devices of all the MNOs are notified about the smart contract registration.

The one or more MNO's NEF devices log on the blockchain network 103 or private database of the blockchain network 103 the following information about the specific end-user identity:
List of end-user location information including:
   Time stamp;
   Number of users in the given area; and
   MNO identifier.

In an embodiment, when no information is available in a certain MNOs' domain, then it is explicitly written in the blockchain network 103 that no information is available for that user.

In the PULL Mode, the AF device 101 performs accesses to the blockchain network 101 regarding data (e.g. notification of the monitored event) from one or more NEF devices belonging to different MNOs; verifies the data availability; and reads the data. This is an example implementation of arrow 3:10 of FIG. 3.

### Example Smart Contract

Table 4 illustrates an example implementation of a smart contract according to one or more embodiments. Although the example has been presented in relation to FIG. 4c, it will be appreciated by those skilled in the art, that a similar smart contract may be provided for embodiments of FIG. 4a and FIG. 4b and any other embodiments. The smart contract comprises the following participating entities: the AF device 101, the NEF devices (e.g. NEF device 1 102, NEF device x 102n), the NF devices (e.g. NF device 1 104, NF device x 104n).

TABLE 4
An example implementation of a smart contract

| | | |
|---|---|---|
| Pn | Producer n | → NF n |
| En | Exposure n | → NEF n |
| C | Consumer | → AF |

| | |
|---|---|
| Specification | data specification by C (example: all subscribers in a location area) |
| Data | data produced by P (requested by C) |

| | |
|---|---|
| Output: | Information provided or not provided |

Procedure:
if sender = C then

| | if specification.request = Register_Contract then | # ... (1) |
|---|---|---|
| | location_id = specification.id | # ... (2) |
| | request_type = specification.type (example: coordinates) | # ... (3) |
| | notify all relevant NEF about contract registration | # ... (4) |
| | contract = incomplete | # ... (5) |
| | return contract_created | # ... (6) |
| else if specification.request = read_data then | | # ... (7) |
| | if contract = completed then | # ... (8) |

| | |
|---|---|
| return data | # ... (9) |

else

| | |
|---|---|
| return no_data | # ... (10) |

| | |
|---|---|
| elsif specification.request = delete_request then | # ... (11) |

return contract_terminated

| else if sender = E1 then | | # ... (12) |
|---|---|---|
| | if data.request = read_request_data | # ... (13) |

return location_id, request_type

| | |
|---|---|
| if data.request = data_provided | # ... (14) |

| data_NEF1 = data | |
|---|---|
| if data_NEF2 = valid then | # ... (15) |

contract = completed

| else if sender = E2 then | | # ... (16) |
|---|---|---|
| | if data.request = read_request_data | # ... (17) |

return location_id, request_type

| | |
|---|---|
| if data.request = data_provided | # ... (18) |

| data_NEF2 = data | |
|---|---|
| if data_NEF1 = valid then | # ... (19) |

contract = completed

else

| | |
|---|---|
| return access denied | # ... (20) |

The implementation steps of Table 4 are described as follows:
(1) AF device 101 creates a new request for registering a smart contract;
(2) Geographical location area (of eg: end-user) is provided by the AF device 101;
(3) Details of the request are provided;
(4) NEF device 1 104 and NEF device x 104n are informed;
(5) Set initial smart contract status;
(6) The smart contract is created;
(7) AF device 101 queries the blockchain network 103 regarding requested data availability;
(8) Check on the request/smart contract identity to verify if the request exists and if data has been produced;
(9) AF device 101 gets the data;
(10) No data is available (yet);
(11) Procedure to terminate the contract;
(12) NEF device 1 104 makes access to the blockchain network 103;
(13) NEF device 1 104 gets information about the location area it needs to query and information about the query type (e.g. the monitoring event type);
(14) NEF device 1 104 writes data in the blockchain network 103;
(15) Check that another NEF device (e.g. NEF device x 104n) has already provided data;
(16) NEF device x 104n makes access to the blockchain network 103;
(17) NEF device x 104n gets information about the location area it needs to query and the query type;
(18) NEF device x 104n writes data in the blockchain network 103;
(19) Check that another NEF device has already provided data;
(20) Neither the AF device 101 nor NEF device 1 104 nor NEF device x 104n have made access to the blockchain network 103.

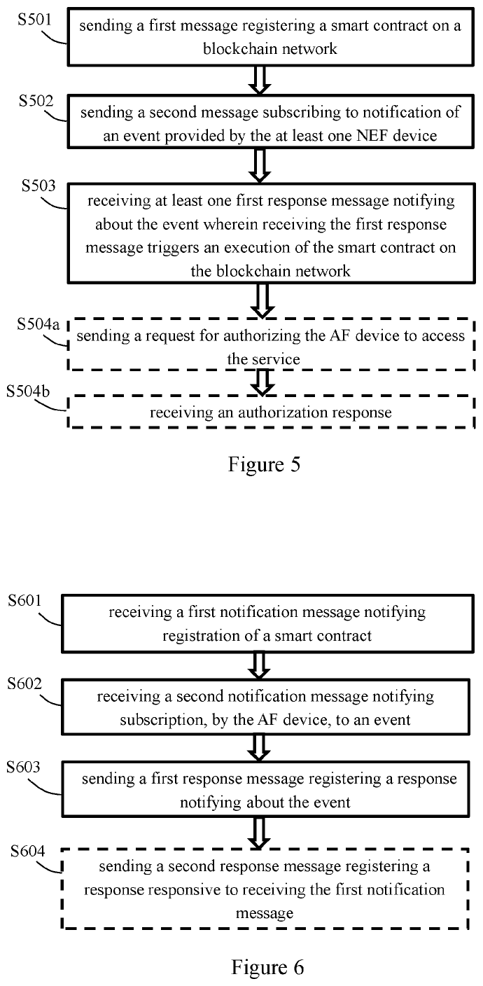

FIG. 5 illustrates a method performed by an AF device 101 according to an embodiment. The method comprises:
At Step S501, sending a first message registering a smart contract on a blockchain network 103, for accessing a service provided by at least one network exposure function, NEF, device (102);
At Step S502, sending a second message subscribing to notification of an event provided by the at least one NEF device (102,102a, 102n); and
At Step S503, receiving at least one first response message notifying about the event, wherein receiving the first response message triggers an execution of the smart contract on the blockchain network (103).

More specifically, at least step illustrated by arrow 3:1 of FIG. 3 is an example of Step S501. At least step illustrated by arrow 3:3 of FIG. 3 is an example of Step S502. At least step illustrated by arrow 3:11 of FIG. 3 is an example of Step S503.

In an optional embodiment, the method further comprises:
At step S504a sending a request for authorizing the AF device (101) to access the service, and
At step 504b, receiving an authorization response, wherein the authorization response includes one of: an indication that the AF device (101) is authorized or an indication that the AF device (101) is not authorized.

FIG. 6 illustrates a method performed by an NEF device (102,102a, 102n) according to an embodiment. The method comprises:
At Step S601, receiving a first notification message notifying registration of a smart contract, wherein the smart contract is registered on a blockchain network (103) by an application function, AF, device (101);
At Step S602, receiving a second notification message notifying about subscription, by the AF device (101), to an event; and
At Step S603, sending a first response message registering a response based on the first notification message.

More specifically, at least step illustrated by arrows 3:2a and 3:2b of FIG. 3 are an example of Step S601. At least step illustrated by arrows 3:4a and 3:4b of FIG. 3 are an example of Step S602. At least step illustrated by arrow 3:9 of FIG. 3 is an example of the Step S603.

In an optional embodiment, the method further comprises:
At Step S604, sending a second response message registering a response responsive to receiving the first notification message.

At least step illustrated by arrow 3:7 of FIG. 3 is an example of Step S604.

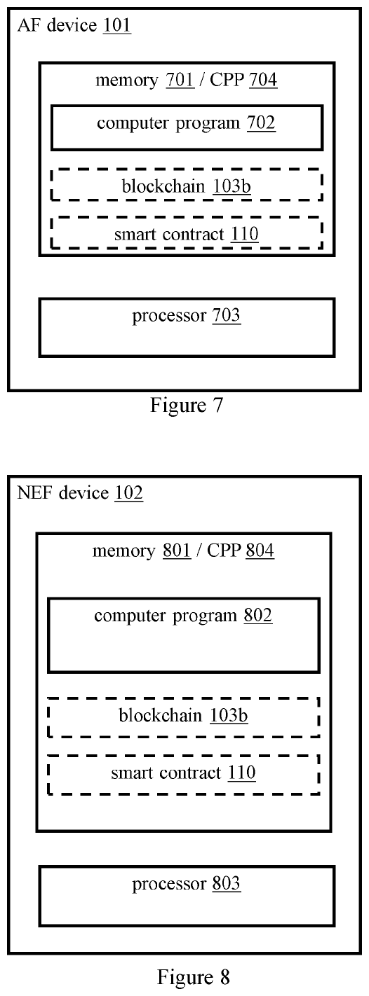

FIG. 7 is a block diagram illustrating an example of the AF device 101 comprising one or more processor(s) 703 and a memory 701, wherein the memory 701 (or computer readable storage medium 701) comprises instructions which when executed by the one or more processors 703 cause the AF device 101 to perform one or more steps of the methods according to FIG. 5 and/or FIG. 3. The AF device 101 may comprise AF functions as specified in the 3GPP standard.

The computer program product 704 comprises a computer program 702, which comprises computer program code loadable into the processor 703, wherein the computer program 702 comprises code executed on the AF device 101 adapted to perform one or more of the steps of the methods of FIG. 5 and/or FIG. 3 and the embodiments described herein, when the computer program code is executed by the processor 703. In other words, the computer program 702 may be the AF device 101 software hosted by the AF device 101.

FIG. 8 is a block diagram illustrating an example of the NEF device 102 such as any one of the NEF devices, e.g. NEF device 1 102, NEF device x 102n, comprising one or more processor(s) 803 and a memory 801, wherein the memory 801 (or computer readable storage medium 801) comprises instructions which when executed by the one or more processors 803 cause the NEF device to perform one or more steps of the methods according to FIG. 6 and/or FIG. 3.

The computer program product 804 comprises a computer program 802, which comprises computer program code loadable into the processor 803, wherein the computer program 802 comprises code executed on the NEF device 102 such as any one of the NEF devices, e.g. NEF device 1 102, NEF device x 102n adapted to perform one or more of the steps of the methods of FIG. 6 and/or FIG. 3 and the embodiments described herein, when the computer program code is executed by the processor 803. In other words, the computer program 802 may be the NEF device 102 software hosted by the NEF device 102.

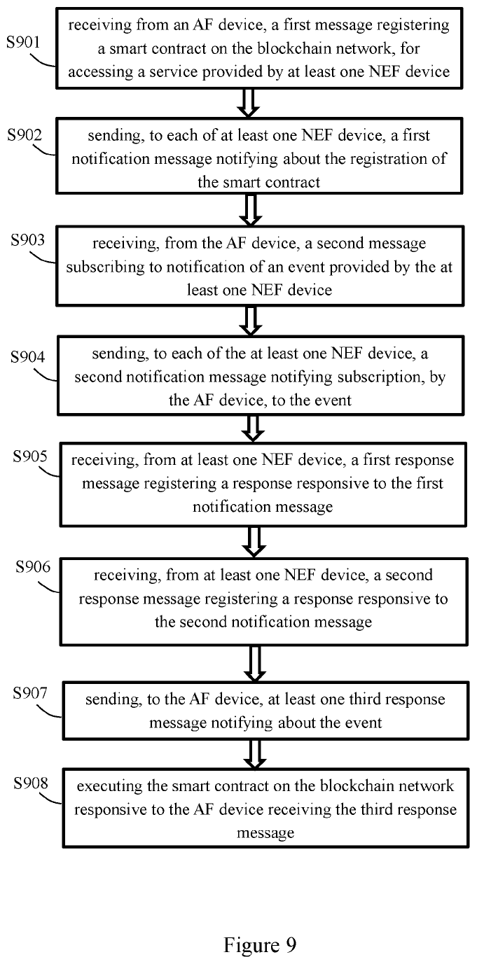

FIG. 9 illustrates a method performed by the blockchain network 103 according to an embodiment. The method comprises:
At step S901, receiving, from an AF device (101), a first message registering a smart contract on the blockchain network (103), for accessing a service provided by at least one network exposure function, NEF, device (102, 102a, 102n);
At step S902, sending, to each of at least one NEF device (102, 102a, 102n), a first notification message notifying about the registration of the smart contract;
At step S903, receiving, from the AF device (101), a second message subscribing to notification of an event provided by the at least one NEF device (102, 102a, 102n);
At step S904, sending, to each of the at least one NEF device (102, 102a, 102n), a second notification message notifying subscription, by the AF device (101), to the event;
At step S905, receiving, from at least one NEF device (102,102a, 102n), a first response message registering a response responsive to the first notification message;
At step S906, receiving, from at least one NEF device (102,102a, 102n), a second response message registering a response responsive to the second notification message;
At step S907, sending, to the AF device (101), at least one third response message notifying about the event; and
At step S908, executing the smart contract on the blockchain network (103) responsive to the AF device (101) receiving the third response message.

More specifically, at least step illustrated by arrows 3:1 of FIG. 3 is an example of Step S901. At least step illustrated by arrows 3:2a and 3:2b of FIG. 3 are an example of Step S902. At least step illustrated by arrow 3:3 of FIG. 3 is an example of the Step S903. At least steps illustrated by arrows 3:4a and 3:4b of FIG. 3 are an example of the Step S904. At least step illustrated by arrow 3:7 of FIG. 3 is an example of the Step S905. At least step illustrated by arrow 3:9 of FIG. 3 is an example of the Step S906. At least step illustrated by arrow 3:10 of FIG. 3 is an example of the Step S907. At least step illustrated by arrow 3:11 of FIG. 3 is an example of the Step S908.

In an embodiment, the method described above in relation to FIG. 9 is performed by a blockchain host 103a of the blockchain network 103.

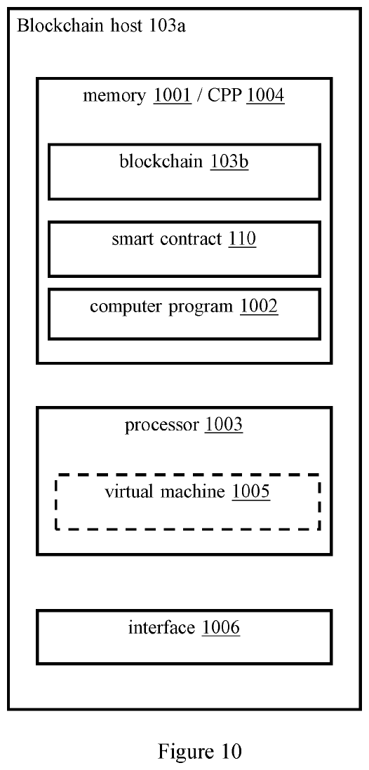

FIG. 10 illustrates a blockchain host 103a of the blockchain network 103. The blockchain host comprises a memory 1001, one or more processors 1003 and an interface 1006. The interface 1006 interacts with a virtual machine 1005 optionally comprised in the processor 1005. The interface may comprise a mobile network/WiFi interface which is used for the transmission or reception of information to/from the communication network. By way of example, when the blockchain host 103a receives a response message registering a response about a monitoring event from the NEF device 102, the interface 1006 may interact and trigger the virtual machine 1005 to operate as discussed above.

The memory 1001 may comprise a blockchain 103b database, a smart contract 110 and a computer program 1002. The blockchain 103b database may include a private database. The blockchain 103b database may store data relating to a transaction. The smart contract 110 may comprise data as described above in the application. The processor 1003 may update a copy of the blockchain 103b database stored in the memory 1001. The blockchain host 103a may update other entities in the network (e.g. blockchain peers, the AF device 101, the NEF device 102) about a newly added block through the interface 1006.

The blockchain host 103a may receive an update about a blockchain from other peer hosts on the blockchain network 103 via the interface 1006. Further, the interface 1006 may internally transmit the update towards the virtual machine 1005 in the processor 1003. The smart contract may be executed and verified in the one or more processors 1003. An internal or external trigger may be used to trigger the execution of the smart contract. For example, the trigger may be the AF device 101 receiving a response message notifying about an event.

The computer program product 1004 comprises a computer program 1002, which comprises computer program code loadable into the processor 1003, wherein the computer program 1002 comprises code executed on the blockchain host 103a adapted to perform one or more of the blockchain network functions (for e.g. the method of FIG. 9 and/or FIG. 3) and its embodiments as described herein, when the computer program code is executed by the processor 1003. In other words, the computer program 1002 may be the blockchain host 103a software hosted by the blockchain host 103a.

The devices, namely the AF device 101, the NEF device 102 and the blockchain host 103a according to FIG. 7, FIG. 8 and FIG. 10 respectively, may have storage and/or processing capabilities. The AF device 101, the NEF device 102 and the blockchain host 103a may include one or more processors 703, 803, 1003 respectively and memory 701, 801, 1001 respectively. In particular, in addition to a traditional processor and memory, the AF device 101, the NEF device 102 and the blockchain host 103a may comprise integrated circuitry for processing and/or control, e.g., one or more processors and/or processor cores and/or Field Programmable Gate Array (FPGA) and/or Application Specific Integrated Circuitry (ASIC) adapted to execute instructions. The processor(s) 703, 803, 1003 may be configured to access (e.g., write to and/or read from) the memory 701, 801, 1001 respectively, which may comprise any kind of volatile and/or nonvolatile memory, e.g., cache and/or buffer memory and/or Random Access Memory (RAM) and/or Read-Only Memory (ROM) and/or optical memory and/or Erasable Programmable Read-Only Memory (EPROM). Furthermore, the memory 701, 801, 1001 may optionally comprise a blockchain 103b database of the blockchain network 103. The memory 701, 801, 1001 may optionally comprise a smart contract 110, for e.g. the smart contract as described above in the application wrt FIGS. 4a, 4b and 4c.

The AF device 101, the NEF device 102, and the blockchain host 103a may be configured to control any of the methods and/or processes described herein and/or to cause such methods, and/or processes to be performed. Processor 703, 803, 1003 corresponds to one or more processors 703, 803 respectively, for performing the AF device 101, the NEF device 102 and the blockchain host 103a functions respectively as described herein. The AF device 101, the NEF device 102 and the blockchain host 103a includes memory 701, 801, 1001 or computer readable storage mediums 701, 801, 1001 respectively, that is configured to store data, programmatic software code and/or other information described herein. The memory 701, 801, 1001 may include instructions which, when executed by the one or more processors 703, 803, 1003 respectively, cause the one or more processors 703, 803, 1003 to perform the processes described herein with respect to the AF device 101, the NEF device 102 and the blockchain host 103a respectively. The instructions may be software (SW) or computer program associated with the AF device 101, the NEF device 102 and the blockchain host 103a.

Thus, the AF device 101, the NEF device 102 and the blockchain host 103a may further comprise SW or computer program, which is stored in, for example, the memory 701, 801, 1001 at the AF device 101, the NEF device 102 and the blockchain host 103a respectively, or stored in external memory (e.g., database) accessible by the AF device 101, the NEF device 102 and the blockchain host 103a respectively. The SW or computer program may be executable by the one or more processors 703, 803, 1003.

Computer program product 704, 804, 1004 may be or comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by one or more processors 703, 803, 1003. The computer program product 704, 804, 1004 may store any suitable instructions, data or information, including a computer program, software, an application including one or more of logic, rules, code, tables, etc. and/or other instructions capable of being executed by one or more processors 703, 803, 1003. The memory 701, 801, 1001 may be used to store any calculations made by one or more processors 703, 803, 1003 respectively. In some embodiments, one or more processors 703, 803, 1003 and the computer program product 704, 804, 1004 may be considered to be integrated.

1. A method performed by an application function, AF,
device, the method comprising:
sending a first message registering a smart contract on a blockchain network, for accessing a service provided by at least one network exposure function, NEF, device;
sending a second message subscribing to notification of an event provided by the at least one NEF device; and
receiving at least one first response message notifying about the event, receiving the first response message triggering an execution of the smart contract on the blockchain network.

2. The method according to claim 1, further comprising:
sending a request for authorizing the AF device to access the service; and
receiving an authorization response, wherein the authorization response includes one of: an indication that the AF device is authorized or an indication that the AF device is not authorized.

3. The method according to claim 1, wherein the AF device is authorized according to a Role-based Authorization Control authorization procedure or a Task-based Authorization Control authorization procedure.

4.-11. (canceled)

12. The method according to claim 1, wherein the AF device is part of the blockchain network.

13. The method according to claim 1, wherein the AF device comprises a blockchain host performing the sending the first message, sending the second message and receiving the at least one first response message.

14.-15. (canceled)

16. A method performed by a network exposure function, NEF, device, the method comprising:
receiving a first notification message notifying about registration of a smart contract, wherein the smart contract is registered on a blockchain network by an application function, AF, device;
receiving a second notification message notifying about subscription, by the AF device, to an event; and
sending a first response message registering a response notifying about the event.

17. The method according to claim 16, further comprising sending a second response message registering a response responsive to receiving the first notification message.

18. The method according to claim 16, wherein the event is a Fifth Generation, 5G, monitoring event or a Sixth Generation, 6G, monitoring event.

19. The method according to claim 16, wherein the 5G monitoring event is at least one of the following events:
User Equipment, UE, reachability;
Location Reporting;
Change of Subscription Permanent Identifier-Permanent Equipment Identifier, SUPI-PEI, association;
Roaming Status;
Number of UEs present in a geographic area; and
UE reachability for Short Message Service, SMS, delivery.

20. The method according to claim 16, wherein when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PULL.

21. The method according to claim 16, wherein when the monitoring event is Location Reporting, the smart contract comprises at least one of the following data:
a Service Capability Server/Application Server, SCS/AS, Identifier;
a Monitoring type;
an end-user identity;
maximum number of reports;
monitoring duration; and
a Mode option set to value PUSH.

22. The method according to claim 16, wherein when the event is Location Reporting, the first response message or the second response message comprises at least one of the following data:
time stamp;
user location information; and
MNO identifier.

23. The method according to claim 16, wherein when the monitoring event is Number of UEs present in a geographic area, the smart contract comprises at least one of the following data:
a Service Capability Server/Application Server, SCS/AS, Identifier;
a Monitoring type;
a monitoring area; and
a Mode option set to value PULL.

24.-25. (canceled)

26. The method according to claim 16, wherein the sending the first response message triggers execution of the smart contract on the blockchain network.

27. The method according to claim 16, wherein the AF device and the NEF device are part of the blockchain network.

28. The method according to claim 16, wherein the NEF device comprises a blockchain host performing the receiving the first notification, receiving the second notification and the sending.

29.-32. (canceled)

33. An application function, AF, device, comprising a memory and processor, the memory containing instructions which when executed on the processor, cause the AF device to:
send a first message registering a smart contract on a blockchain network, for accessing a service provided by at least one network exposure function, NEF, device;
send a second message subscribing to notification of an event provided by the at least one NEF device; and
receive at least one first response message notifying about the event wherein receiving the first response message triggers an execution of the smart contract on the blockchain network.

34. The AF device according to claim 33, the memory containing instructions which when executed on the processor, further cause the AF device to:
send a request for authorizing the AF device to access the service; and
receive an authorization response, wherein the authorization response includes one of: an indication that the AF device is authorized or an indication that the AF device is not authorized.

35. The AF device according to claim 33, wherein the AF device is authorized according to a Role-based Authorization Control authorization procedure or a Task-based Authorization Control authorization procedure.

36.-39. (canceled)

40. A computer readable storage medium storing a computer program comprising instructions which, when executed on:
an application function, AF, device causes the AF device to:
send a first message registering a smart contract on a blockchain network for accessing a service provided by at least one network exposure function, NEF, device;
send a second message subscribing to notification of an event provided by the at least one NEF device; and
receive at least one first response message notifying about the event, receiving the first response message triggering an execution of the smart contract on the blockchain network; or
a network exposure function, NEF, device causes the NEF device to:
receive a first notification message notifying about registration of a smart contract, wherein the smart contract is registered on a blockchain network by an application function, AF, device;
receive a second notification message notifying about subscription, by the AF device), to an event; and
send a first response message registering a response notifying about the event.

41.-44. (canceled)
